(19) United States
(12) Patent Application Publication
(10) Pub. No.: US 2008/0092191 A1
(43) Pub. Date: Apr. 17, 2008

(54) DYNAMIC PROGRAM REBROADCAST

(76) Inventor: Tod A. DeBie, Costa Mesa, CA (US)

Correspondence Address: TOD DEBIE, 2190 PLACENTIA AVE., # C, COSTA MESA, CA, 92627, US

(21) Appl. No.: 11/535,079

(22) Filed: Sep. 26, 2006

(51) Int. Cl. H04N 7/173; G06F 3/00; G06F 13/00; H04N 7/16; H04N 5/445

(52) U.S. Cl. 725/116; 725/114; 725/144; 725/146; 725/58

(57) ABSTRACT

A method of negotiating the rebroadcast of a desired program, comprising: determining that a desired program is available for rebroadcast; selecting a specific rebroadcast time; communicating the specific rebroadcast time to the television service provider; and setting the desired program to record at the selected rebroadcast time.

### BACKGROUND OF THE INVENTION—FIELD OF INVENTION

This invention generally relates to television program viewing and recording, specifically to arranging a dynamic rebroadcast of conflicted, preempted or otherwise un-viewable or un-recordable programs.

### BACKGROUND OF THE INVENTION

Recording systems for television programs such as digital video recorders allow users to easily record selected programs. Digital video recorders typically include a tuner so that the broadcast of a desired program may be singled out and viewed or recorded, a storage medium where the system stored the program for later viewing and a user interface to enable the user to control what programs are recorded and what programs are viewed. They may also include a program guide, which shows what programs are on what channels at what times to enable the user to easily select a desired program for viewing or recording. Such systems may be entirely self contained, such as in a set top box, or they have multiple separate parts, such as separate tuners and storage mediums, such as in software based systems intended to run on one or more computers with storage and tuners, etc. Such systems have one or more tuners and the number of programs they can record simultaneously are limited to the number of tuners in the system such that a system with two tuners would allow any of the following: the user can watch one live program, the user can watch one live program and record another, or the user can record two programs but cannot watch a live program other than the two being recorded. Some systems will allow the user to watch a pre-recorded program while all of the tuners are busy recording live programs.

A common issue encountered in the course of using a digital video recorder is a recording conflict. A recording conflict occurs when there are not enough tuners available to record all desired programs. A recording conflict also occurs when there are not enough tuners available to record all desired programs while servicing a live program viewing request from the user.

For example, if a two tuner digital video recorder is currently recording two programs and the user wants to either record or watch a third program, a recording conflict arises because there are not enough tuners available to service all the requests.

When a recording conflict occurs in existing systems, they typically give the user the option to either keep the current recording(s) going or to abandon one of them in favor of the new recording or viewing selection. If the user wants to record or view all of the programs, they will have to manually search for other times when the programs are on and manually set them to record or watch them live to resolve the conflict, or they will have to manually check to see if the desired program is available via video on demand. This is undesirable and may cause the loss of recorded information as well as inconveniencing a potential end user.

Other common issues include the pre-emption of a desired program by another program, such as a sport event or news broadcast, an equipment malfunction or power loss that prevents the recording or viewing of a desired program. Again, in these cases it is up to the user to manually search for other times with the programs are on and manually set them to record, check to see if the desired program is available via video on demand or otherwise ensure that they are watching the desired program at the future date and time of its scheduled broadcast. This is undesirable and may cause the loss of recorded information as well as inconveniencing a potential end user.

There remains a need in the art for systems and methods to resolve these and other problems in a more efficient manner.

### SUMMARY

Accordingly, several advantages are provided, according to one or more embodiments, which may include relieving users of the burden of manually resolving recording and viewing conflicts, preemptions and other issues where a desired program is unable to be viewed and/or recorded by automatically determining from the television programming service provider, such as a cable or satellite television provider, if one of the conflicted programs is available for a retransmission at an unconflicted time, negotiating a selected rebroadcast time, and recording the program at the negotiated time, thereby enabling the desired program to be viewed or recorded.

Further advantages will become apparent from a consideration of the drawings and ensuing description.

### BRIEF DESCRIPTION OF DRAWINGS

Aspects of this disclosure are illustrated by way of example, and not by way of limitation, in the accompanying drawings, wherein:

FIG. 1 depicts how an embodiment of the invention resolves viewing and recording conflicts, pre-emption, power loss and other conflicts or issues that prevent a desired program from being viewed or recorded through attempting to negotiate a later unconflicted rebroadcast of the desired program.

### DETAILED DESCRIPTION

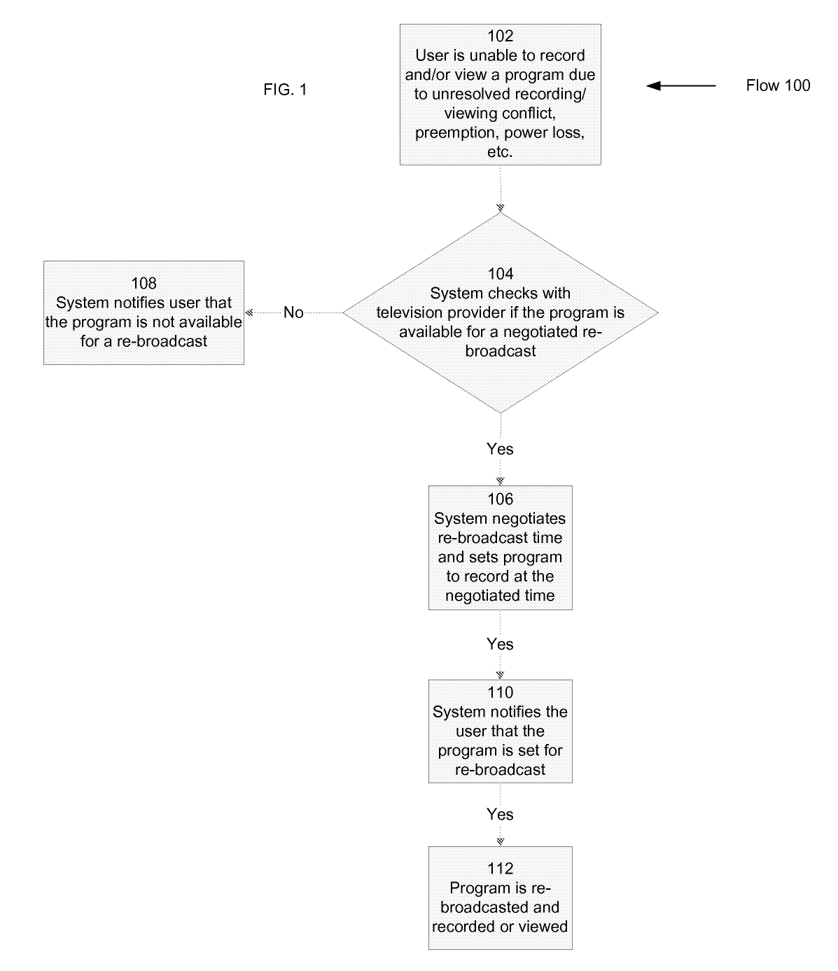

FIG. 1 depicts a flowchart of an exemplary method for resolving viewing and recording conflicts, pre-emption, power loss and other conflicts or issues that prevent a desired program from being viewed or recorded through attempting to negotiate a later unconflicted rebroadcast of the desired program. In reference to FIG. 1, an exemplary recording resolution flow 100 may comprise one or more operations as follows:

In operation 102, a user is unable to record and/or view a program due to unresolved viewing and recording conflicts, pre-emption, power loss or other conflicts or issues.

For example, if a user wants to record program A and B, both of which are playing at the same time but on different channels and the user is working with a single tuner DVR, a recording conflict is encountered.

Alternatively, the program recording may have been missed because of a power or equipment failure, because the DVR was off; or the program may not be recordable because it was preempted by news, sport or some other event or program.

In operation 104, the system determines if the program is available for rebroadcast at a later unconflicted time. According to one embodiment, the DVR will determine if either program A or B is available for retransmission at a later unconflicted time by sending a request to the television service provider to determine if and when program A and B are available for retransmission.

In another embodiment, the television service provider includes rebroadcast availability information in the program guide data.

The rebroadcast availability information will typically say that the program is or is not available for rebroadcast and, if it is available, the rebroadcast availability information will typically say how long the rebroadcast will be available for.

In another embodiment, all programs in the system are available for rebroadcast. In another embodiment, all programs in the system are available for rebroadcast at any time. Operation 104 may be optional for one or both of these embodiments.

For example, it might say that the desired program is available for rebroadcast for the next 24 hours.

If a rebroadcast is determined to not be available in operation 104, the system may, in operation 108, notify the user that the desired program is not available for rebroadcast. In other embodiments, the system may not notify the user.

If a rebroadcast is determined to be available in operation 104, the system may, in operation 106, negotiate a specific rebroadcast time for the desired program and set the program to record at the negotiated time.

For example, if it is determined in operation 104 that the desired program is available for rebroadcast for 24 hours from the time the check in operation 104 is done, the system may then select a specific time in the next 24 hours where there are no other recording conflicts to record the desired program and set the program to record at that time. The system may then communicate to the television service provider the desired rebroadcast time and the television service provider will transmit the desired program to the DVR at the negotiated time and the program will be recorded and/or viewed in operation 112.

In general, rebroadcast times can be scheduled any time after the moment the desired program starts.

In other embodiments, the system may first communicate to the television service provider the desired rebroadcast time and then set the program to record at that time.

In some embodiments, the system may, after operation 106, notify the user that the desired program is set for rebroadcast and recording in operation 110. In other embodiments, the user may not be notified.

In some embodiments, the system may rebroadcast the desired program on an available or currently un-used channel. In other embodiments, the system may rebroadcast the desired program over the Internet or other private network, satellite link or any other appropriate broadcast medium.

In any embodiment, the rebroadcast may happen at normal speed or at a speed other than normal.

I claim:

1. A method of negotiating the rebroadcast of a desired program, comprising:
determining that a desired program is available for rebroadcast;
selecting a desired rebroadcast time; and
communicating the desired rebroadcast time to a television service provider.

2. The method of claim 1, further comprising:
re-broadcasting the desired program at the selected time.

3. The method of claim 1, further comprising:
setting the desired program to record at the selected rebroadcast time.

4. The method of claim 1, further comprising:
enabling the user to control if they want said rebroadcasts to be set.

5. The method of claim 1, further comprising:
notifying the user if a rebroadcast recording has been set.

6. A method of rebroadcasting a desired program, comprising:
re-broadcasting a desired program at a selected time.

7. The method of claim 6, further comprising:
determining that a desired program is available for rebroadcast.

8. The method of claim 6, further comprising:
determining that a desired program is available for rebroadcast;
selecting a desired rebroadcast time; and
communicating the desired rebroadcast time to a television service provider.

9. A system for re-broadcasting a desired program, comprising:
means for re-broadcasting a desired program at a selected time.

10. The system of claim 9, further comprising:
means for determining that a desired program is available for rebroadcast.

11. The system of claim 9, further comprising:
means for determining that a desired program is available for rebroadcast;
means for selecting a desired rebroadcast time; and
means for communicating the desired rebroadcast time to a television service provider.
